(19) United States
(12) Patent Application Publication
(10) Pub. No.: US 2009/0096147 A1
(43) Pub. Date: Apr. 16, 2009

(54) Vise holding and manipulation device

(76) Inventor: Spyros Chaidemenos, London (CA)

Correspondence Address: Anissimoff & Associates;Suite 201, 235 North Centre Road, London, N5X 4E7, CA

(21) Appl. No.: 12/285,859

(22) Filed: Oct. 15, 2008

Related U.S. Application Data
(60) Provisional application No. 60/960,807, filed on Oct. 15, 2007.

(51) Int. Cl. B25B 1/20; B23Q 1/25; B25B 1/00

(52) U.S. Cl. 269/43; 269/55; 269/153

(57) ABSTRACT

This herein taught technology relates in general to milling machine apparatus for reducing inaccuracies associated with mounting fixtures on a milling machine surface having a movable guide. It comprises a loading arm which is secured directly within the jaws of the vise to permit manipulation of the vise at the end thereof. The device is secured directly to the milling machine apparatus or adjacent wall surface to permit convenient use of the device and safe storage of the vise when not in use.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### TECHNICAL FIELD OF THE INVENTION

The herein taught technology relates in general to a device used to store, remove and install a vise on a milling machine or the like.

### BACKGROUND OF THE INVENTION

As is known, a vise is used in conjunction with milling machines to hold the workpiece during the machining process. The vise is mounted on the milling machine work table which typically is vertically and horizontally adjustable.

A milling machine operator must of necessity use and change vises to accommodate different workpieces and fabrication procedures. This repetitively requires the operator to remove the existing vise from the work table and replace it with a desired vise. This removal and replacement operation poses safety risks to the operator as the vise is heavy and awkward to handle. There is accordingly a need for a device to assist in the process of storage, removal and replacement of vises on milling machine and the like.

There exist previously known vise manipulation device. For example, the device disclosed in U.S. Pat. No. 5,344,264 discloses a vise holding device having special adaptor plates attached to the interface of both jaw faces in order to maintain a secure grip on the vise. U.S. Pat. No. 3,038,385 discloses a machine with two loading arms integral to its body used to manipulate a vise. Each arm projects outwardly from the machine and is adapted to hold a variety of milling tools by means of a first hook mechanism at the arms distal end. In operation, a second hook element is secured between the jaws of the vise for attachment to the first hook.

Further features of the invention will be described or will become apparent in the course of the following detailed description.

As will be seen from the subsequent description of the preferred embodiments of the herein taught technology, the above mentioned shortcomings of the previously known technologies are overcome by the present technique.

### BRIEF SUMMARY OF THE INVENTION

In view of the foregoing disadvantages inherent in the known types of apparatus with vise holding apparatuses, the herein taught technique provides improvement by a simple, integral, device used to store, remove and install a vise on a milling machine or the like.

To accomplish this, the herein taught technique provides an apparatus arranged for association with a loading arm which is secured directly within the jaws of the vise to permit manipulation of the vise at the end thereof. It includes a vise holding and manipulation device to hold the vise and permit its horizontal movement with reference to the top surface of the milling machine.

The improved device according to this technique does not require any separate components. It comprises a loading arm which is secured directly within the jaws of the vise to permit manipulation of the vise at the end thereof. The device is secured directly to the milling machine frame or adjacent wall surface to permit convenient use of the device and safe storage of the vise when not in use. The vise holding and manipulation device according to this invention serves to hold the vise and permit its horizontal movement with reference to the top surface of the material fabrication aperture.

The device is fixedly mounted to any adjacent structure and has three hingedly connected arms to allow for a wide area of horizontal motion for the vise so held. The device functions by having its distal arm secured between the jaws of the vise in a conventional fashion. In operation, the surface of the milling table is vertically adjusted to permit the distal arm to be placed between the jaw surfaces and clamped there between. The vise is then unfastened from the material fabrication aperture and the work table is lowered to release the framed device which is now fully supported by the device. The vise can now be moved clear of the work table and stored. The vise can be returned to the material fabrication aperture in opposite fashion from its previously stored position and reattached to the work table.

The herein taught technology resides not in any one of these features per se, but rather in the particular combination of all of them herein disclosed and claimed and it is distinguished from the previously known field in the particular combination of all of its structures for the functions specified.

There have thus been outlined, rather broadly, the more important features of the herein taught technology in order that the detailed description thereof that follows may be better understood, and in order that the present contribution to the technique may be better appreciated. There are, of course, additional features of the technique that will be described hereinafter and which will form the subject matter of the claims appended hereto. Those skilled in the field will appreciate that the conception, upon which this disclosure is based, may readily be utilized as a basis for the designing of other structures, methods and systems for carrying out the several purposes of the herein taught technology. It is important, therefore, that the claims be regarded as including such equivalent constructions insofar as they do not depart from the spirit and scope of the technology.

Further, the purpose of the included abstract is to enable the U.S. Patent and Trademark Office and the public generally, and especially the scientists, engineers and practitioners in the field who are not familiar with patent or legal terms or phraseology, to determine quickly from a cursory inspection the nature and essence of the technical disclosure of the application. The abstract is neither intended to define the technique of the application, which is measured by the claims, nor is it intended to be limiting as to the scope of the herein taught technology in any way.

### OBJECTS OF THE INVENTION

One object of the herein described technology is to provide a new and improved vise holding and manipulation device which has all the useful advantages of the previously known vise handling devices and none of the previously associated disadvantages of inconvenience, assembly requirements, obstructive characteristics, or other obstacles to efficient use.

A further object of the herein taught technology is to provide a new and improved vise holding and manipulation devices which may be inexpensively incorporated as an improvement on, and integral to, present versions and designs of vise handling devices or other tool handling devices.

Still another object of the present technique is to provide an improved vise holding and manipulation system wherein the guide member may be inexpensively manufactured as part of, and included as part and parcel to, the associated cutting device.

Still another object of the present technique is to provide an improved vise holding and manipulation system wherein the ability to make it “left or right handed” by means of disassembly of the hinge between the arms.

A notable and novel characteristic of this technology is the vise which is secured to the load arm conventionally using the clamping force of the vise jaws is the primary attachment means used to prevent the vise from slipping out of securement.

The above, and other, objects of the herein taught technology, along with the various features of novelty which characterize the technique, are pointed out with particularity in the claims annexed to and forming a part of this disclosure. For a better understanding of the herein taught technology, its operating advantages and the specific objects attained by its uses, reference should be had to the accompanying drawings and descriptive matter in which there are illustrated preferred embodiments of the technique.

### BRIEF DESCRIPTION OF THE DRAWINGS

The above summarized aspects of the herein taught technology, plus other additional aspects, will be apparent from the description below and from the appended drawings, which are meant to illustrate and not to limit the technique, and wherein:

FIG. 1 is a perspective view of the device, constructed in accordance with the herein thought technology;

FIG. 2 is a cross sectional view taken at AA of FIG. 1 of the herein taught technology thereof.

### LIST OF NUMBERED ELEMENTS

1 mounting plate

1a drilled holes

1b threaded holes

2&3 support arms

4 load arm

5 hinge joints

7 docking flange

8 docking flange aperture

9 adjustable pins

11 horizontally aligned apertures

12 screw

13 sliding element

16 hinge plate

17 protruding pin

### DETAILED DESCRIPTION OF THE INVENTION

In the following detailed description of the preferred embodiments, reference is made to the accompanying drawings which form a part hereof, and in which is shown by way of illustration specific preferred embodiments in which the herein taught technology may be practiced. These embodiments are described in detail to enable those skilled in the field to practice the taught technology, and it is to be understood that other embodiments may be utilized and that logical, mechanical and manufacturing changes may be made without departing from the spirit or scope of the technique.

The conceptual groundwork for the herein taught technology involves providing a milling machine apparatus for reducing inaccuracies associated with mounting fixtures on a milling machine surface having a movable guide.

The device according to herein taught technology comprises a mounting plate 1 which is hingedly connected to support arms 2 and 3 and load arm 4 at the distal end of the device to which the vise is attached in operation. As can be seen, three hinge joints 5 interconnect each arm of the device. The mounting plate 1 is used to fixedly attach the device to an adjacent wall structure or directly to the frame of a material fabrication aperture. The arms above described permit lateral or horizontal movement and strength and the load arm 4 is secured within the jaws of the vise allowing the vise to be thereby easily manipulated by the operator in a horizontal plane.

The mounting plate 1 consists of four drilled holes 1a and four threaded holes 1b which are used to securely attach and align the device with reference to the support structure (not shown) such as an adjacent wall or material fabrication aperture. The threaded holes are provided with adjustment screws to permit the device to be vertically aligned with reference to the milling table. The interior ends of the adjustment screws engage the surface of the wall or machine frame and may be independently manipulated to effect vertical alignment of the mounting plate and therefore horizontal alignment of the device. The drilled holes are used to directly attach the device to the supporting structure by means of any suitable screw and/or bolt type attachment means.

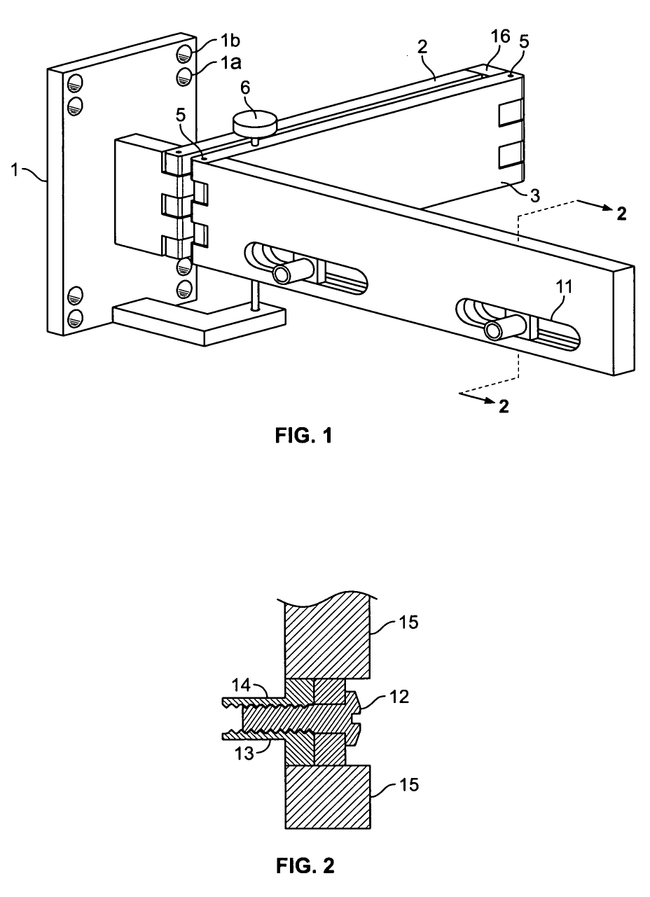

FIG. 1 shows the device in the stored position. A stopper (not shown) is attached to the mounting plate and projects outwardly there from to stop the rearward swing of arm 2 substantially parallel to the supporting surface. The stopper functions to stop the rearwardly swing of the arm 2 in a predetermined position to permit docking of the device as will be hereafter described. As can be seen arm 3 folds parallel to arm 2. Arm 3 has an outwardly biased plunger installed at the end thereof as shown which is used to secure arm 3 within aperture 8 of docking flange 7 to thereby dock and store the vise.

The vise is secured to the load arm conventionally using the clamping force of the vise jaws which is the primary attachment means used to prevent the vise from slipping out of securement. To further prevent the vise from slippage from the loading arm, horizontally adjustable pins 9 are provided in two complementary horizontally aligned apertures 11 provided in the loading arm as shown.

As shown in FIG. 2 the pins are securely held within the horizontal aperture by means of a screw 12 which engages the rear of the slide element 13 having a forward protruding pin 17. As can be seen, the pin is adjusted horizontally by means of sliding along the horizontal dovetail formed length of the aperture and is threadingly secured in position against the vertical surfaces of the dovetail element 13.

The pins are adjusted and aligned to be insertable into the screw or bolt head apertures of the screw and/or bolt elements which secure the jaws to the vise body. There are typically two such attachment points for each jaw. The pins are inserted into the aperture formed in the head of the screw and/or bolt element aforesaid which is typically Allen key shaped. The pins are located within the head of these elements and serve to further prevent the jaws slipping out of engagement with the load arm.

The device could be made “left or right handed” by means of disassembly of the hinge between arm 2 and arm 3 shown at B in FIG. 1 by means of removal of the hinge plate 16 which is removably connected to the end of arm 2. The hinge plate 16 is reversed and oppositely attached to the end of arm 2 which transfers the swing area of the arms of the device from the left side to the right side and vice versa.

The above description is intended to be illustrative, and not restrictive. Many other embodiments will be apparent to those skilled in the field. The scope of the herein taught technology should therefore be determined by the appended claims, along with the full scope of equivalents to which such claims are entitled.

While, the following description is presented enabling a person of ordinary skill in the field for making and using the technology is provided in the context of the requirement for obtaining a patent. The present description is the best presently-contemplated method for carrying out the herein taught technology. Various modifications to the preferred embodiment will be readily apparent to those skilled in the field and the generic principles of the herein taught technology may be applied to other embodiments, and some features of the herein taught technology may be used without the corresponding use of other features. Accordingly, the herein taught technology is not intended to be limited to the embodiment shown but is to be accorded the widest scope consistent with the principles and features described herein

What is claimed is:

1. A system for manipulating a vise on a milling machine, the manipulating system comprising:
a mounting plate adapted to mount on a milling machine work table in a vertical or horizontal position for storing the vise on the milling machine;
a milling machine operator adapted to be replaced with a desired vise for removing the vise from the milling machine; and
a milling machine frame adapted to lower the milling machine work table for installing the desired vise on the milling machine.

2. The system of claim 1, further comprising a loading arm adapted to manipulate securely within a set of jaws of the vise.

3. The system of claim 1, further comprising a milling machine frame adapted to store the vise.

4. The system of claim 1, wherein the vise holding device adapted to hold the vise and facilitate horizontal movement on the milling machine frame.

5. The system of claim 1, further comprising a set of arms adapted for facilitating horizontal movement to mount on the milling machine frame.

6. The system of claim 1, wherein the loading arm includes a distal arm secured within the set of jaws of the vise in a conventional manner.

7. The system of claim 1, further comprising a milling table surface adapted to be vertically adjusted for permitting the distal arm placed between the set of jaws.

8. The system of claim 1, further comprising a work table adapted to be lowered for releasing the milling machine frame.

9. The system of claim 8, wherein the work table is stored by clearing the work table and moving the vise.

10. The system of claim 1, further comprising the vise is returned to the milling machine in an opposite manner comparatively to a stored position and reattached to a milling table.

11. The system of claim 1, further comprising a mounting plate adapted to be connected to the set of jaws.

12. The method of claim 11, wherein the mounting plate comprises a set of drilled holes and a set of threaded holes for attaching and aligning the milling machine.

13. A system for holding and manipulation of milling machine vise, wherein the device further comprising:
a plurality of screws or bolts to engage the surface of the wall or device frame;
wherein the mounting plate having a plurality of drilled or threaded holes along with the adjustment screws, which are used to securely attach and align the device with the reference to the support structure such as an adjacent wall or milling machine; and
a stopper attached to the mounting plate which projects outwardly therefore to stop the rearward swing of the arm;
wherein the stopper functions to stop the rearwardly swing of the arm, with one of the support arm outwardly biased plunger installed at the end of it folds in a predetermined position to thereby permit dock and store the device vise; and
wherein the vise is secured to one of the arms conventionally using the clamping force of the vise jaws which is the primary attachment means used to prevent the vise from slipping out of securement.

14. A system for holding and manipulation of milling machine vise as claimed in claim 13, wherein the housing of the pins are the screws or bolt head apertures of the screw or bolt elements which secure the jaws to the vise body.

15. A system for holding and manipulation of milling machine vise as claimed in claim 13, wherein the aperture formed in the head of the screw or bolt element aforesaid is typically allen key shaped.

16. A system for holding and manipulation of milling machine vise as claimed in claim 13, wherein the pins located within the head of these elements to further prevent the jaws slipping out of engagement with the load arm.

17. A holding and manipulation device vise, wherein the device comprising a work table to and from which a vise is to be transported and manipulated, the vise having opposed jaws with means for their clamped engagement with a member therebetween, and including;
means to permit convenient use of the device and safe storage of the vise when not in use; means to easily manipulate the vise by the operator in a horizontal plane; means permitting docking of the device;
means to prevent the vise from slippage from the loading arm; wherein the hinge plate is reversed and oppositely attached to the end of arm which transfers the swing area of the arms;
wherefrom the device can be shifted from the left side to the right side and vice versa.
